(19) United States
(12) Patent Application Publication
(10) Pub. No.: US 2026/0342414 A1
(43) Pub. Date: Oct. 29, 2026

(54) USER EQUIPMENT BEAM CAPABILITIES GIVEN BEAM CONFIGURATIONS IN PREDICTIVE BEAM MANAGEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US); Tao LUO, San Diego, CA (US)

(21) Appl. No.: 19/099,183

(22) PCT Filed: Sep. 29, 2022
(86) PCT No.: PCT/CN2022/122376

§ 371 Date: Jan. 28, 2025

(51) Int. Cl. H04B 7/06; H04B 17/318

(52) U.S. Cl. CPC H04B 7/06952; H04B 17/328

(57) ABSTRACT

Methods, systems, and devices for wireless communication are described. A network node (e.g., a user equipment (UE)) may transmit capability information indicating a quantity of beams, a type of beams, or both for which the network node is capable of generating beam predictions. The beam quantity and type may be based on a quantity, type, or both of available reference signal resources. The network node may receive control information indicating a quantity of reference signal resources, a type of reference signal resources, or both to use as measurement resources for beam prediction, and indicating a quantity of beams, a type of beams, or both to monitor as beam prediction targets. The network node may monitor the measurement resources and generate beam predictions accordingly, and the network node may transmit beam prediction results in a report.

### CROSS REFERENCE

The present Application is a 371 national phase filing of International PCT Application No. PCT/CN2022/122376 by LI et al., entitled “USER EQUIPMENT BEAM CAPABILITIES GIVEN BEAM CONFIGURATIONS IN PREDICTIVE BEAM MANAGEMENT,” filed Sep. 29, 2022, which is assigned to the assignee hereof, and which is expressly incorporated by reference in its entirety herein.

### INTRODUCTION

The following relates to wireless communications relating to predictive beam management.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support user equipment (UE) beam capabilities given beam configurations in predictive beam management. For example, the described techniques provide for a UE (e.g., a first network node) to report a capability to generate beam predictions given a set of beam configurations in a predictive beam management procedure. The UE may report its capability to generate beam predictions for a first quantity of beams, a first type of beams, or both, based on a first quantity of available reference signal resources, a first type of available reference signal resources, or both. A network entity (e.g., a second network node) may transmit control signaling to the UE indicating a quantity of reference signal resources, a type of reference signal resources, or both which the UE may use as measurement resources for beam prediction. In addition, the control signaling may indicate a quantity of beams, a type of beams, or both to monitor as beam prediction targets, where the reference signal resources and beams indicated by the control signaling may be based on the capabilities of the UE.

The UE may monitor the measurement resources in accordance with the quantity of beams, the type of beam, or both indicated by the control signaling to perform predictive beam management.

A method for wireless communication at a first network node is described. The method may include transmitting capability information including information indicative of at least one of: a first quantity of beams for which the first network node is capable of generating beam predictions or a first type of beam for which the first network node is capable of generating the beam predictions, where the information is based on a quantity of available reference signal resources or a type of available reference signal resources for beam prediction, receiving, based on the capability information, control information including information indicative of a quantity of reference signal resources or a type of reference signal resources to use as measurement resources for beam prediction, and information indicative of a quantity of beams or a beam type to monitor as beam prediction targets, and monitoring the measurement resources in accordance with the quantity of beams or the beam type indicated by the control information.

A first network node for wireless communication is described. The first network node may include a memory, and at least one processor coupled to the memory, where the at least one processor is configured to transmit capability information including information indicative of at least one of: a first quantity of beams for which the first network node is capable of generating beam predictions or a first type of beam for which the first network node is capable of generating the beam predictions, where the information is based on a quantity of available reference signal resources or a type of available reference signal resources for beam prediction, receive, based on the capability information, control information including information indicative of a quantity of reference signal resources or a type of reference signal resources to use as measurement resources for beam prediction, and information indicative of a quantity of beams or a beam type to monitor as beam prediction targets, and monitor the measurement resources in accordance with the quantity of beams or the beam type indicated by the control information.

Another apparatus for wireless communication at a first network node is described. The apparatus may include means for transmitting capability information including information indicative of at least one of: a first quantity of beams for which the first network node is capable of generating beam predictions or a first type of beam for which the first network node is capable of generating the beam predictions, where the information is based on a quantity of available reference signal resources or a type of available reference signal resources for beam prediction, means for receiving, based on the capability information, control information including information indicative of a quantity of reference signal resources or a type of reference signal resources to use as measurement resources for beam prediction, and information indicative of a quantity of beams or a beam type to monitor as beam prediction targets, and means for monitoring the measurement resources in accordance with the quantity of beams or the beam type indicated by the control information.

A non-transitory computer-readable medium having code for wireless communication stored thereon is described. The code, when executed by a first network node, cause the first network node to transmit capability information including information indicative of at least one of: a first quantity of beams for which the first network node is capable of generating beam predictions or a first type of beam for which the first network node is capable of generating the beam predictions, where the information is based on a quantity of available reference signal resources or a type of available reference signal resources for beam prediction, receive, based on the capability information, control information including information indicative of a quantity of reference signal resources or a type of reference signal resources to use as measurement resources for beam prediction, and information indicative of a quantity of beams or a beam type to monitor as beam prediction targets, and monitor the measurement resources in accordance with the quantity of beams or the beam type indicated by the control information.

In some examples of the method, apparatuses, and non-transitory computer-readable medium described herein, the control information includes the information indicative of the type of reference signal resources, where the information indicative of the type of reference signal resources identifies a reference signal resource periodicity.

In some examples of the method, apparatuses, and non-transitory computer-readable medium described herein, the control information includes the information indicative of the type of reference signal resources, where the information indicative of the type of reference signal resources identifies that the type of reference signal resources may be associated with single-port channel state information reference signal (CSI-RS) transmission, or may be associated with multi-port CSI-RS transmission.

In some examples of the method, apparatuses, and non-transitory computer-readable medium described herein, the control information includes the information indicative of the type of reference signal resources, where the information indicative of the type of reference signal resources identifies that the type of reference signal resources may be associated with synchronization signal block (SSB) transmission.

In some examples of the method, apparatuses, and non-transitory computer-readable medium described herein, the capability information includes the information indicative of the first type of beam, where the information indicative of the first type of beam identifies whether the first type of beam for which the first network node may be capable of generating the beam predictions includes a beam communicated via reference signal resources configured as the measurement resources.

In some examples of the method, apparatuses, and non-transitory computer-readable medium described herein, the capability information includes the information indicative of the first type of beam, where the information indicative of the first type of beam identifies a periodicity associated with the first type of beam for which the first network node may be capable of generating the beam predictions.

In some examples of the method, apparatuses, and non-transitory computer-readable medium described herein, the capability information includes the information indicative of the first type of beam, where the information indicative of the first type of beam identifies a quantity of future time domain occasions for which the first network node may be capable of generating the beam predictions, a time interval between adjacent future time domain occasions for the beam prediction, or both.

Some examples of the method, apparatuses, and non-transitory computer-readable medium described herein may further include operations, features, means, or instructions for receiving signaling indicating a set of combinations of quantities of available reference signal resources and types of available reference signal resources to use as the measurement resources for the beam prediction.

In some examples of the method, apparatuses, and non-transitory computer-readable medium described herein, the capability information includes the information indicative the first quantity of beams or the first type of beam for which the first network node may be capable of generating the beam predictions, where the information may be based on the set of combinations of quantities of available reference signal resources and types of available reference signal resources indicated by the signaling.

In some examples of the method, apparatuses, and non-transitory computer-readable medium described herein, transmitting the capability information may include operations, features, means, or instructions for transmitting the capability information based on a type of report in which the first network node may be capable of transmitting beam prediction results.

In some examples of the method, apparatuses, and non-transitory computer-readable medium described herein, receiving the control information may include operations, features, means, or instructions for receiving the control information based on a type of report in which the first network node may be capable of transmitting beam prediction results.

Some examples of the method, apparatuses, and non-transitory computer-readable medium described herein may further include operations, features, means, or instructions for transmit a report including one or more beam prediction results based on the monitored measurement resources.

In some examples of the method, apparatuses, and non-transitory computer-readable medium described herein, transmitting the capability information may include operations, features, means, or instructions for transmit the capability information during an initial access procedure.

Some examples of the method, apparatuses, and non-transitory computer-readable medium described herein may further include operations, features, means, or instructions for receiving a serving cell configuration for the first network node and transmitting, based on the serving cell configuration, the capability information.

In some examples of the method, apparatuses, and non-transitory computer-readable medium described herein, the quantity of reference signal resources may be associated with the quantity of available reference signal resources and the type of reference signal resources may be associated with the type of available reference signal resources.

A method for wireless communication at a second network node is described. The method may include receiving capability information including information indicative of at least one of: a first quantity of beams for which a first network node is capable of generating beam predictions or a first type of beam for which the first network node is capable of generating the beam predictions, where the information is based on a quantity of available reference signal resources or a type of available reference signal resources for beam prediction, transmitting, based on the capability information, control information including information indicative of a quantity of reference signal resources or a type of reference signal resources as measurement resources for beam prediction, and information indicative of a quantity of beams or a beam type to monitor as beam prediction targets, and transmitting the measurement resources in accordance with the quantity of beams or the beam type indicated by the control information.

A second network node for wireless communication is described. The second network node may include a memory, and at least one processor coupled to the memory, where the at least one processor is configured to receive capability information including information indicative of at least one of: a first quantity of beams for which a first network node is capable of generating beam predictions or a first type of beam for which the first network node is capable of generating the beam predictions, where the information is based on a quantity of available reference signal resources or a type of available reference signal resources for beam prediction, transmit, based on the capability information, control information including information indicative of a quantity of reference signal resources or a type of reference signal resources as measurement resources for beam prediction, and information indicative of a quantity of beams or a beam type to monitor as beam prediction targets, and transmit the measurement resources in accordance with the quantity of beams or the beam type indicated by the control information.

Another apparatus for wireless communication at a second network node is described. The apparatus may include means for receiving capability information including information indicative of at least one of: a first quantity of beams for which a first network node is capable of generating beam predictions or a first type of beam for which the first network node is capable of generating the beam predictions, where the information is based on a quantity of available reference signal resources or a type of available reference signal resources for beam prediction, means for transmitting, based on the capability information, control information including information indicative of a quantity of reference signal resources or a type of reference signal resources as measurement resources for beam prediction, and information indicative of a quantity of beams or a beam type to monitor as beam prediction targets, and means for transmitting the measurement resources in accordance with the quantity of beams or the beam type indicated by the control information.

A non-transitory computer-readable medium having code for wireless communication stored thereon is described. The code, when executed by a second network node, causes the network node to receive capability information including information indicative of at least one of: a first quantity of beams for which a first network node is capable of generating beam predictions or a first type of beam for which the first network node is capable of generating the beam predictions, where the information is based on a quantity of available reference signal resources or a type of available reference signal resources for beam prediction, transmit, based on the capability information, control information including information indicative of a quantity of reference signal resources or a type of reference signal resources as measurement resources for beam prediction, and information indicative of a quantity of beams or a beam type to monitor as beam prediction targets, and transmit the measurement resources in accordance with the quantity of beams or the beam type indicated by the control information.

In some examples of the method, apparatuses, and non-transitory computer-readable medium described herein, the control information includes the information indicative of the type of reference signal resources, where the information indicative of the type of reference signal resources identifies a reference signal resource periodicity.

In some examples of the method, apparatuses, and non-transitory computer-readable medium described herein, the control information includes the information indicative the type of reference signal resources, where the information indicative of the type of reference signal resources identifies that the type of reference signal resources may be associated with single-port CSI-RS transmission, or may be associated with multi-port CSI-RS transmission.

In some examples of the method, apparatuses, and non-transitory computer-readable medium described herein, the control information includes the information indicative of the type of reference signal resources, where the information indicative of the type of reference signal resources identifies that the type of reference signal resources may be associated with SSB transmission.

In some examples of the method, apparatuses, and non-transitory computer-readable medium described herein, the capability information includes the information indicative of the first type of beam, where the information indicative of the first type of beam identifies whether the first type of beam for which the first network node may be capable of generating the beam prediction includes a beam communicated via reference signal resources configured as the measurement resources.

In some examples of the method, apparatuses, and non-transitory computer-readable medium described herein, the capability information includes the information indicative of the first type of beam, where the information indicative of the first type of beam identifies a periodicity associated with the first type of beam for which the first network node may be capable of generating the beam predictions.

In some examples of the method, apparatuses, and non-transitory computer-readable medium described herein, the capability information includes the information indicative of the first type of beam, where the information indicative of the first type of beam identifies a quantity of future time domain occasions for which the first network node may be capable of generating the beam predictions, a time interval between adjacent future time domain occasions for the beam prediction, or both.

Some examples of the method, apparatuses, and non-transitory computer-readable medium described herein may further include operations, features, means, or instructions for transmitting signaling indicating a set of combinations of quantities of available reference signal resources and types of available reference signal resources to use as the measurement resources for the beam prediction.

In some examples of the method, apparatuses, and non-transitory computer-readable medium described herein, the capability information includes the information indicative of the first quantity of beams or the first type of beam for which the first network node may be capable of generating the beam predictions, where the information may be based on the set of combinations of available quantities of reference signal resources and available types of reference signal resources indicated by the signaling.

In some examples of the method, apparatuses, and non-transitory computer-readable medium described herein, receiving the capability information may include operations, features, means, or instructions for receiving the capability information based on a type of report in which the first network node may be capable of transmitting beam prediction results.

In some examples of the method, apparatuses, and non-transitory computer-readable medium described herein, transmitting the control information may include operations, features, means, or instructions for transmitting the control information based on a type of report in which the first network node may be capable of transmitting beam prediction results.

Some examples of the method, apparatuses, and non-transitory computer-readable medium described herein may further include operations, features, means, or instructions for receiving a report including one or more beam prediction results based on the transmitted measurement resources.

In some examples of the method, apparatuses, and non-transitory computer-readable medium described herein, receiving the capability information may include operations, features, means, or instructions for receiving the capability information during an initial access procedure.

Some examples of the method, apparatuses, and non-transitory computer-readable medium described herein may further include operations, features, means, or instructions for transmitting a serving cell configuration for the first network node and receiving, based on the serving cell configuration, the capability information.

In some examples of the method, apparatuses, and non-transitory computer-readable medium described herein, the quantity of reference signal resources may be associated with the quantity of available reference signal resources and the type of reference signal resources may be associated with the type of available reference signal resources.

### BRIEF DESCRIPTION OF THE DRAWINGS

FIG. 1 illustrates an example of a wireless communications system that supports user equipment (UE) beam capabilities given beam configurations in predictive beam management in accordance with one or more aspects of the present disclosure.

FIG. 2 illustrates an example of a wireless communications system that supports UE beam capabilities given beam configurations in predictive beam management in accordance with one or more aspects of the present disclosure.

FIG. 3 illustrates an example of a process flow that supports UE beam capabilities given beam configurations in predictive beam management in accordance with one or more aspects of the present disclosure.

FIGS. 4 and 5 show block diagrams of devices that support UE beam capabilities given beam configurations in predictive beam management in accordance with one or more aspects of the present disclosure.

FIG. 6 shows a block diagram of a communications manager that supports UE beam capabilities given beam configurations in predictive beam management in accordance with one or more aspects of the present disclosure.

FIG. 7 shows a diagram of a system including a device that supports UE beam capabilities given beam configurations in predictive beam management in accordance with one or more aspects of the present disclosure.

FIGS. 8 and 9 show block diagrams of devices that support UE beam capabilities given beam configurations in predictive beam management in accordance with one or more aspects of the present disclosure.

FIG. 10 shows a block diagram of a communications manager that supports UE beam capabilities given beam configurations in predictive beam management in accordance with one or more aspects of the present disclosure.

FIG. 11 shows a diagram of a system including a device that supports UE beam capabilities given beam configurations in predictive beam management in accordance with one or more aspects of the present disclosure.

FIGS. 12 through 16 show flowcharts illustrating methods that support UE beam capabilities given beam configurations in predictive beam management in accordance with one or more aspects of the present disclosure.

### DETAILED DESCRIPTION

In some wireless communications systems, a user equipment (UE) may use artificial intelligence (AI) or machine learning model-based beam management. For example, a UE may perform beam predictions for a first set of beams (e.g., narrow beams) based on measurement results of a second set of beams (e.g., wide beams), such that the UE may utilize or avoid using particular beams. However, the complexity of such AI or machine learning models may depend on dimensions of the inputs and outputs to the models, and as such, the models may become overly complex. That is, the more inputs and outputs are associated with the model, the more complex the model may become, which may increase overhead and power consumption. Moreover, the UE may have limited hardware resources, software resources, or both for running the AI or machine learning models. Because of these limitations, a network entity may be unable to indicate or configure arbitrary combinations of beams from the first set of beams and the second set of beams, which may limit the UE's ability to accurately make beam predictions.

The techniques described herein enable a UE (e.g., a first network node) to report a capability to generate beam predictions given a set of beam configurations in a predictive beam management procedure. The UE may report its capability to generate beam predictions for a first quantity of beams, a first type of beams, or both, based on a first quantity of available reference signal resources, a first type of available reference signal resources, or both. A network entity (e.g., a second network node) may transmit control signaling to the UE indicating a quantity of reference signal resources, a type of reference signal resources, or both which the UE may use as measurement resources for beam prediction. In addition, the control signaling may indicate a quantity of beams, a type of beams, or both to monitor as beam prediction targets, where the reference signal resources and beams indicated by the control signaling may be based on the capabilities of the UE. The UE may monitor the measurement resources in accordance with the quantity of beams, the type of beam, or both indicated by the control signaling to perform predictive beam management.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to UE beam capabilities given beam configurations in predictive beam management.

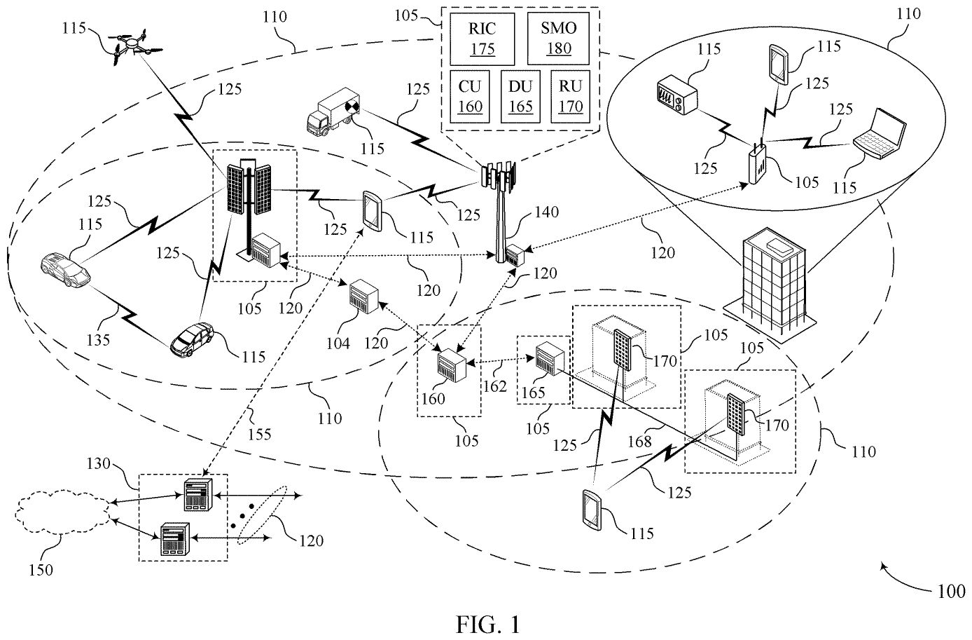

FIG. 1 illustrates an example of a wireless communications system 100 that supports UE beam capabilities given beam configurations in predictive beam management in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support UE beam capabilities given beam configurations in predictive beam management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

A UE 115 may perform various beam management procedures, for example, to make beam predictions based on measurements of other beams. Such beam management (including beam predictions in the time domain, spatial domain, or both) may reduce overhead and latency for the UE 115, while also improving beam selection accuracy. ‘Using some beam management procedures, a UE 115 may identify beam qualities and failures using measurements (e.g., reference signal received power (RSRP) measurements). These measurements may increase power and overhead consumption at the UE 115 if the UE 115 is to achieve improved signaling performance. In addition, restrictions to power and overhead consumption may limit beam accuracy, and beam resuming efforts may increase latency and decrease signaling throughput. To reduce such power and overhead consumption, and to improve beam accuracy, latency, and throughput, a UE 115 may use predictive beam management (in the time domain, frequency domain, and spatial domain). Using predictive beam management techniques, the UE 115 may predict non-measured beam qualities, which may result in lower power and overhead or improved beam accuracy, and the UE 115 may predict future beam blockages or failures, which may improve latency and signaling throughput.

In some aspects, UEs 115 may use AI or machine learning model-based predictive beam management procedures because beam prediction is highly non-linear. For example, predicting qualities of future transmit beams may depend on a moving speed or trajectory of the UE 115, which receive beams the UE 115 may use, interference, and other factors that may be difficult to model via statistical signaling processing methods. In some aspects, a wireless device (e.g., a UE 115 or a network entity 105) may use a machine learning model for beam prediction in the time domain, the spatial domain, or both for overhead and latency reduction and improvements in beam selection accuracy.

Whether a UE 115 or a network entity 105 performs the machine learning model-based beam management may be based on performance and power of the UE 115. For example, to predict future downlink transmit beam qualities, a UE 115 may make more observations (e.g., via measurements) than a network entity 105 (e.g., via UE feedback), thus predictions made by the UE 115 may outperform those made by the network entity 105 as the UE 115 may consume less power for interference efforts. Moreover, training the machine learning model at the UE 115 or the network entity 105 may be based on data collection efforts and UE computation. For example, training the machine learning model at the network entity 105 may include collecting data via an air interface (e.g., an enhanced air interface) or via an Application (APP) layer approach. Alternatively, training the machine learning model at the UE 115 may include additional computation or buffering efforts at the UE 115 to perform accurate model training and adequate data storage.

In some aspects of AI or machine learning model-based beam management, wireless devices may support two cases of beam management for characterization and baseline performance evaluations. In a first case (e.g., BM-Case 1), a UE 115 may perform spatial-domain downlink beam predictions for a first set of beams (e.g., Set A) based on measurement results of a second set of beams (e.g., Set B). In some cases, the second set of beams may be a subset of the first set of beams, where the first and second sets of beams may be different (e.g., the first set of beams may include narrow beams, and the second set of beams may include wide beams). Additionally, or alternatively, the UE 115 may use the first set of beams for downlink beam prediction and the second set of beams for downlink beam measurement. In a second case (e.g., BM-Case2), the UE 115 may perform temporal downlink beam prediction for the first set of beams based on historic (e.g., previous, past) measurement results of the second set of beams. For both cases, beams in the first and second set of beams may be in a same frequency range.

In some cases, a complexity of an AI or machine learning model used for beam management may be based on quantities of beams used as inputs and outputs to the model (e.g., Set-A and Set-B beams). Put another way, the complexity of such a model depends on the dimensions of the inputs and the outputs to the model. In some aspects, the UE 115 may know (e.g., the network entity 105 may configure) a quantity of beam prediction targets, which may include predicted L1-RSRPs (e.g., narrow beams transmitted via CSI-RSs). For example, the network entity 105 may configure the UE 115 to predict 4 or 8 beams (e.g., Set-A beams). The network entity 105 may then provide the UE 115 with some measurement results (e.g., Set-B beams, measured L1-RSRPs, synchronization signal blocks (SSBs), or CSI-RSs) to use for the beam predictions. For example, the network entity 105 may provide the UE 115 with 2 wide-beam measurements to predict 4 narrow-beams, or 4 wide-beam measurements to predict 8 narrow-beams. The UE 115 may use a deep neural network (DNN) or a convolutional neural network (CNN) to predict the beams based on the measurement results. In this way, the UE 115 may use a wider or deeper DNN or CNN to predict the beams (e.g., Set-A) when more measurement results (e.g., Set-B) are configured.

For example, a first machine learning model (using a DNN or a CNN) may have inputs of L1 RSRPs regarding 8 SSBs for a past 8 SSB measurement occasions, and outputs of predicted L1-RSRPs regarding 24 non-zero-power (NZP) CSI-RSs corresponding to a CSI reference resources associated with a CSI report. The first machine learning model may have up to 3 hidden layers, while a dimension of a most complex layer may be up to 128. Alternatively, a second machine learning model (using a DNN or a CNN) may have inputs of L1-RSRPs regarding 16 SSBs for a past 36 SSB measurement occasions, and outputs of predicted L1-RSRPs regarding 64 NZP-CSI-RSs corresponding to CSI reference resources associated with a CSI report. The second machine learning model may have up to 5 hidden layers, while a dimension of a most complex layer may be up to 512.

In some cases, the UE 115 may have limited AI or machine learning model inference hardware and software resources. Because of such hardware and software limitations at the UE 115, the network entity 105 may be unable to configure or indicate arbitrary combinations of quantities of Set-A and Set-B beams (e.g., inputs and outputs to the machine learning model), which may further limit the UE 115 from performing accurate beam predictions.

The wireless communications system 100 may support a UE 115 (e.g., a first network node) reporting a capability to generate beam predictions given a set of beam configurations in a predictive beam management procedure. For example, the UE 115 may report its capability to make beam predictions on a quantity or type of Set-A beams (e.g., beam predictions) given a quantity or type of Set-B beams (e.g., beam measurement results), such that the UE 115 may expect a network entity 105 (e.g., a second network node) to configure the quantities and types of Set-A beams and Set-B beams that the UE 115 supports. In some aspects, the indication and configuration of the type of Set-A beams and Set-B beams may include a periodicity of the Set-B beams, or whether the Set-B beams are associated with single-port CSI-RS, multi-port CSI-RS, or SSB transmissions. Additionally, or alternatively, for time-domain beam prediction, the indication and configuration may include a quantity of future time-domain occasions predicted for the Set-A beams, an interval between adjacent future time-domain occasions predicted for the Set-A beams, or both.

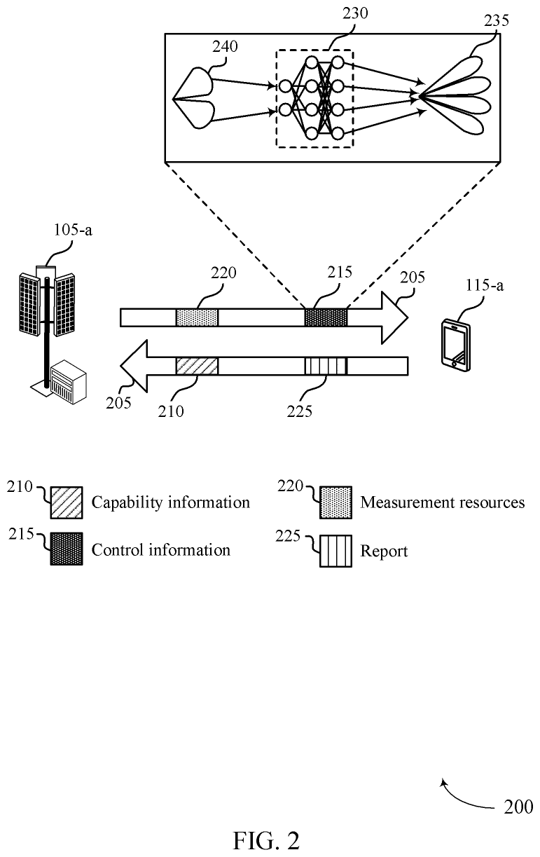

FIG. 2 illustrates an example of a wireless communications system 200 that supports UE beam capabilities given beam configurations in predictive beam management in accordance with one or more aspects of the present disclosure. In some aspects, the wireless communications system 200 may implement aspects of the wireless communications system 100 or may be implemented by aspects of the wireless communications system 100. For example, the wireless communications system 200 may include a UE 115-a (e.g., a first network node) and a network entity 105-a (e.g., a second network node), which may be examples of corresponding devices as described herein. In some aspects, the wireless communications system 200 may support beam prediction by the UE 115-a, where the UE 115-a may use a machine learning model 230 (e.g., or an AI model, including a DNN or a CNN) to predict a set of beams 235 (e.g., Set-A beams) based on measurement results from a set of beams 240 (e.g., Set-B beams).

The wireless communications system 200 may support communications between the UE 115-a and the network entity 105-a, for example, for UE capability reporting that associates the set of beams 235 and the set of beams 240. In some cases, the UE 115-a and the network entity 105-a may communicate via respective communication links 205, which may be examples of communication links 125 described herein with reference to FIG. 1.

The UE 115-a may be capable of supporting a quantity of reference signal resources, one or more types of reference signal resources, or both, and a quantity of beams, a type of beam, or both, for beam prediction. Such reference signal resources and beams may be associated with the set of beams 235, which may be a set of predicted beams by the UE 115-a (e.g., narrow beams). The UE 115-a may transmit capability information 210 to the network entity 105-a including information indicative of at least one of a first quantity of beams for which the UE 115-a is capable of generating beam predictions or a first type of beam for which the UE 115-a is capable of generating the beam predictions. The first quantity of beams and the first type of beam may be based on at least one of a quantity of available reference signal resources for beam prediction, a type of available reference signal resources for beam prediction, or both.

Based on the capability information 210, the network entity 105-a may configure the set of beams 240 which the UE 115-a may use as measurement results (e.g., beam measurements and measurement resources) to predict the set of beams 235 included in the capability information 210. The UE 115-a may receive control information 215 including information indicative of a quantity of reference signal resources, a type of reference signal resources, or both to use as measurement resources for beam prediction, and including information indicative of a quantity of beams or a beam type to monitor as beam prediction targets. In this way, the UE 115-a may report its capabilities on a quantity of beams, type of beam, or both that the UE 115-a may predict (and report measurements for) for a particular number of reference signal resources, a particular type or reference signal resources, or both configured and indicated by the network entity 105-a as the measurement resources 220 for the beam prediction.

The UE 115-a may expect the network entity 105-a to configure and indicate the quantity and type of reference signal resources as the measurement resources 220, and the quantity and type of beams as prediction targets that the UE 115-a supports and reported support for in the capability information 210. By signaling the capability information 210 and the control information 215 in this way, the quantity of reference signal resources may be associated with the quantity of available reference signal resources, and the type of reference signal resources may be associated with the one or more types of available reference signal resources. In addition, the network entity 105-a may configure the set of beams 235 and the set of beams 240 based on the capabilities of the UE 115-a (including software and hardware capabilities) such that the machine learning model 230 has a manageable complexity.

The UE 115-a may monitor the measurement resources 220 in accordance with the quantity of beams, the beam type, or both indicated by the control information 215. In some cases, the UE 115-a may monitor the measurement resources 220 and make one or more beam predictions. The UE 115-a may transmit a report 225 to the network entity 105-a indicating one or more beam prediction results associated with the beam predictions. In some aspects, based on receiving the report 225, the network entity 105-a may transmit an uplink or downlink grant to the UE 115-a that specifies which transmit beam or receive beam the UE 115-a is to use for communicating with the network entity 105-a based on the beam prediction results. For example, if the beam prediction results indicate a beam blockage, the grant may indicate that the UE 115-a is to use an alternative beam to avoid the blockage and consequent transmission failures.

In some aspects, the network entity 105-a may specify one or more parameters when configuring and indicating the type of reference signal resources as measurement resources 220 for the beam prediction. For example, the type may include a periodicity of the reference signal resources, where the information indicative of the type of reference signal resources included in the control information 215 may identify a reference signal resource periodicity. Additionally, or alternatively, the network entity 105-a may indicate whether the reference signal resources are associated with single-port CSI-RS transmissions, SSB transmissions, or multi-port CSI-RS transmissions. That is, the information indicative of the type of reference signal resources included in the control information 215 may identify that the type of reference signal resources is associated with a single-port CSI-RS transmission, an SSB transmission, or a multi-port CSI-RS transmission.

Additionally, or alternatively, the UE 115-a may further specify the type of beams that the UE 115-a may predict and include in the report 225. For example, the UE 115-a may indicate whether the predicted beams (e.g., the set of beams 235) include beams carrying the reference signal resources configured as the measurement resources 220. That is, the information indicative of the first type of beam included in the capability information 210 may identify whether the first type of beam for which the UE 115-a is capable of generating the beam predictions includes a beam communicated via reference signal resources configured as the measurement resources 220.

In some aspects, the UE 115-a may indicate whether the predicted beams are also periodically transmitted with a periodicity much longer than that of the reference signal resources configured as the measurement resources 220 (e.g., via CSI-RS or SSB), or if the network entity 105-a completely refrains from transmitting the predicted beams. In such cases, the information indicative of the type of beam included in the capability information 210 may identify a periodicity associated with the first type of beam for which the UE 115-a is capable of generating the beam predictions. Additionally, or alternatively, for time-domain beam predictions, the UE 115-a may indicate a quantity of future time-domain occasions predicted for the beams, an interval between adjacent future time-domain occasions predicted for the beams, or both. In this way, the information indicative of the type of beam included in the capability information 210 may identify the quantity of future time-domain occasions for which the UE 115-a is capable of generating the beam predictions, the time interval between the adjacent future time-domain occasions for the beam prediction, or both. Such time-domain occasion capabilities of the UE 115-a may be useful as the machine learning model 230 may become more complex the further in the future the UE 115-a generates beam predictions.

The UE 115-a may use different capability reporting frameworks for transmitting the capability information 210. For example, the UE 115-a may identify one or more beams it is capable of supporting from a set of beams either predefined for the UE 115-a or preconfigured by the network entity 105-a for the UE 115-a. In some aspects, the network entity 105-a may configure multiple options of combinations of different quantities and types of reference signal resources as the measurement resources 220, which the UE 115-a may use to generate the beam predictions. Alternatively, the multiple options of combinations of the reference signal resources may be predefined for the UE 115-a.

In some aspects, the combinations may be defined such that the UE 115-a may expect the quantity of reference signal resources configured as the measurement resources 220 to be 4, 8, or 16, and the type of reference signal resources configured as the measurement resources 220 to be at least some or all of the options as described herein. That is, the type of reference signal resources may be associated with a given periodicity, single-port or multi-port CSI-RS transmissions, SSB transmissions, or any combination thereof. In some other examples, the network entity 105-a may further configure, via a system information message or a specific serving cell configuration, the reference signal resources such that the UE 115-a may expect a subset of the combinations that are predefined for the UE 115-a.

Additionally, the network entity 105-a may configure multiple options of combinations of different quantities and types of beams for which the UE 115-a is capable of generating beam predictions. Alternatively, the multiple options of combinations of the beams may be predefined for the UE 115-a. For example, it may be predefined that the UE 115-a is to report (in the report 225) a maximum quantity of predicted beams from a potential quantity of 24, 48, or 64 beams. In addition, the type of predicted beams may be configured to be at least some or all of the options as described herein. That is, the type of predicted beams may be associated with the measurement resources 220, a specific periodicity, some future time-domain occasions and corresponding intervals between adjacent time-domain occasions, or a combination thereof. In some cases, the network entity 105-a may further configure, via a system information message or a specific serving cell configuration, the beams such that the UE 115-a may report a subset of a quantity of combinations that are predefined for the UE 115-a.

For each combination of quantities and types of reference signal resources configured by the network entity 105-a or predefined and down-selected by the network entity 105-a as the measurement resources 220, the UE 115-a may report (in the report 225) a combination of the quantities and types of measured and predicted beams that are predefined for the UE 115-a or further down-selected by the network entity 105-a. In this way, the UE 115-a may receive signaling from the network entity 105-a indicating a set of combinations of the quantities of available reference signal resources and the types of available reference signal resources to use as the measurement resources for the beam prediction. Then, the UE 115-a may transmit the capability information 210 indicating the first quantity of beams, the first type of beam, or both for which the UE 115-a is capable of generating the beam predictions based on the set of combinations of quantities of available reference signal resources and types of available reference signal resources indicated by the signaling.

In some cases, the reference signal resources and beams predefined or configured by the network entity 105-a for the UE 115-a, the UE capabilities included in the capability information 210, or any combination thereof may be divided into different cases based on which methods the UE 115-a uses to carry the prediction results in the report 225. For example, the report 225 may include a MAC control element (MAC-CE), or a periodic, semi-persistent, or aperiodic CSI report. In this way, the UE 115-a may transmit the capability information 210 based on a type of the report 225 in which the UE 115-a is capable of transmitting the beam prediction results. Additionally, or alternatively, the UE 115-a may receive the control information 215 based on the type of the report 225.

The network entity 105-a and the UE 115-a may configure and support the set of beams 235 and the set of beams 240 depending on whether a specific serving cell is configured for the UE 115-a. In some aspects, a full set of a quantity of reference signal resources and a type of reference signal resources may be predefined for the UE 115-a as the measurement resources 220. In addition, a full set of UE-reportable capabilities on the quantity and type of predicted beams may be configured for the UE 115-a without any down-selection process by the network entity 105-a via a system information message or a serving cell-specific configuration. In such cases, the UE 115-a may report its related capabilities with any other UE capabilities at a single time (e.g., in the report 225) during initial access. That is, the UE 115-a may transmit the capability information 210 during an initial access procedure.

Alternatively, the network entity 105-a may configure, and the UE 115-a may update its capabilities regarding different quantities and types of reference signal resources and beams based on a specific serving cell of the UE 115-a. The UE 115-a may expect updated configurations from the network entity 105-a regarding the quantity and type of reference signal resources as the measurement resources 220, the quantity and type of predicted beams, or both, when the UE 115-a is configured with a new serving cell. In addition, the UE 115-a may update its capabilities for each configured serving cell. That is, the UE 115-a may receive a serving cell configuration for the UE 115-a, and based on the serving cell configuration, the UE 115-a may transmit the capability information 210.

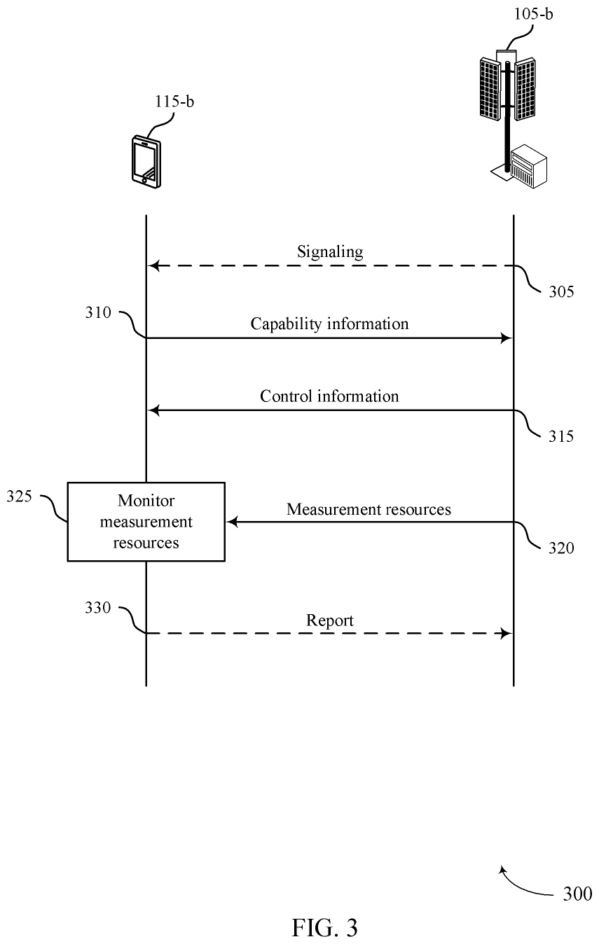

FIG. 3 illustrates an example of a process flow 300 that supports UE beam capabilities given beam configurations in predictive beam management in accordance with one or more aspects of the present disclosure. The process flow 300 may implement aspects of wireless communications systems 100 and 200, or may be implemented by aspects of the wireless communications system 100 and 200. For example, the process flow 300 may illustrate operations between a UE 115-b (e.g., a first network node) and a network entity 105-b (e.g., a second network node), which may be examples of corresponding devices described herein. In the following description of the process flow 300, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 300, and other operations may be added to the process flow 300.

At 305, the UE 115-b may receive, from the network entity 105-b, signaling indicating a set of combinations of quantities of available reference signal resources and types of available reference signal resources to use as measurement resources for beam prediction. The set of combinations may be predefined for the UE 115-b, configured by the network entity 105-b, or down-selected by the network entity 105-b for selection by the UE 115-b.

At 310, the UE 115-b may transmit, to the network entity 105-b, capability information including information indicative of at least one of: a first quantity of beams for which the UE 115-b is capable of generating beam predictions or a first type of beam for which the UE 115-b is capable of generating the beam predictions, wherein the information is based on a quantity of available reference signal resources or a type of available reference signal resources for beam prediction. That is, the UE 115-b may indicate its support for generating beam predictions for a particular quantity and type of beam (e.g., Set-B beams) based on a particular quantity and type of reference signal resources. In some cases, the UE 115-b may select the information included in the capability information based on the combinations indicated by the signaling.

At 315, the UE 115-b may receive, from the network entity 105-b and based on the capability information, control information including information indicative of a quantity of reference signal resources or a type of reference signal resources to use as measurement resources for beam prediction, and information indicative of a quantity of beams or a beam type to monitor as beam prediction targets. In this way, the network entity 105-b may configure a particular quantity and type of reference signal resources and a particular quantity and type of beams (e.g., Set-A beams) the UE 115-b may generate beam predictions for based on the capabilities of the UE 115-b to support the reference signal resources and beams indicated by the capability information.

At 320, the network entity 105-b may transmit, to the UE 115-b, the measurement resources in accordance with the quantity of beams or the beam type indicated by the control information. At 325, the UE 115-b may monitor the measurement resources in accordance with the quantity of beams or the beam type indicated by the control information. The UE 115-b may monitor the measurement resources to perform measurements or generate beam predictions for beams corresponding to the quantity or beam type indicated by the control information.

At 330, the UE 115-b may transmit, to the network entity 105-b, a report including one or more beam prediction results based on the monitored measurement resources. In some cases, the network entity 105-b may transmit a grant back to the UE 115-b identifying one or more beams the UE 115-b is to use for communications with the network entity 105-b based on the beam prediction results included in the report.

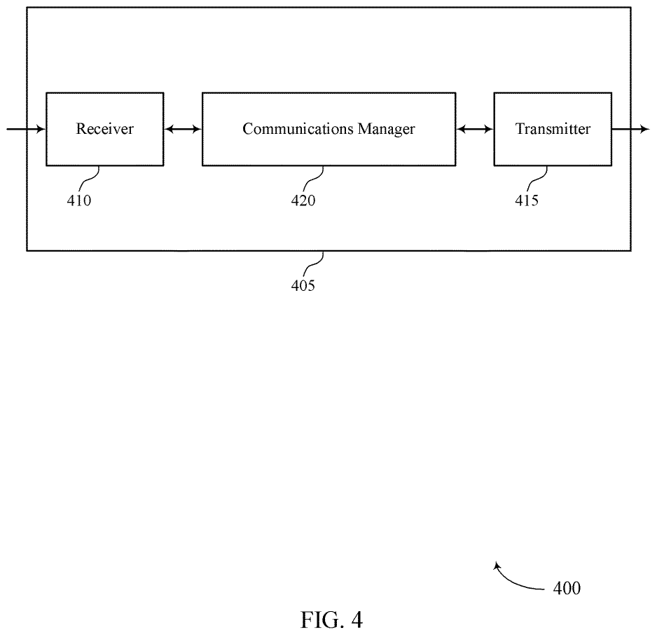

FIG. 4 shows a block diagram 400 of a device 405 that supports UE beam capabilities given beam configurations in predictive beam management in accordance with one or more aspects of the present disclosure. The device 405 may be an example of aspects of a first network node as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to UE beam capabilities given beam configurations in predictive beam management). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to UE beam capabilities given beam configurations in predictive beam management). In some aspects, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of UE beam capabilities given beam configurations in predictive beam management as described herein. For example, the communications manager 420, the receiver 410, the transmitter 415, or various combinations or components thereof may support a method for performing one or more of the functions described herein.

In some aspects, the communications manager 420, the receiver 410, the transmitter 415, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a first network node in accordance with examples as disclosed herein. For example, the communications manager 420 may be configured as or otherwise support a means for transmitting capability information including information indicative of at least one of: a first quantity of beams for which the first network node is capable of generating beam predictions or a first type of beam for which the first network node is capable of generating the beam predictions, where the information is based on a quantity of available reference signal resources or a type of available reference signal resources for beam prediction. The communications manager 420 may be configured as or otherwise support a means for receiving, based on the capability information, control information including information indicative of a quantity of reference signal resources or a type of reference signal resources to use as measurement resources for beam prediction, and information indicative of a quantity of beams or a beam type to monitor as beam prediction targets. The communications manager 420 may be configured as or otherwise support a means for monitoring the measurement resources in accordance with the quantity of beams or the beam type indicated by the control information.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reporting beam capabilities based on beam configurations, which may increase signaling efficiency, reduce overhead and power consumption, and improve communications between wireless devices.

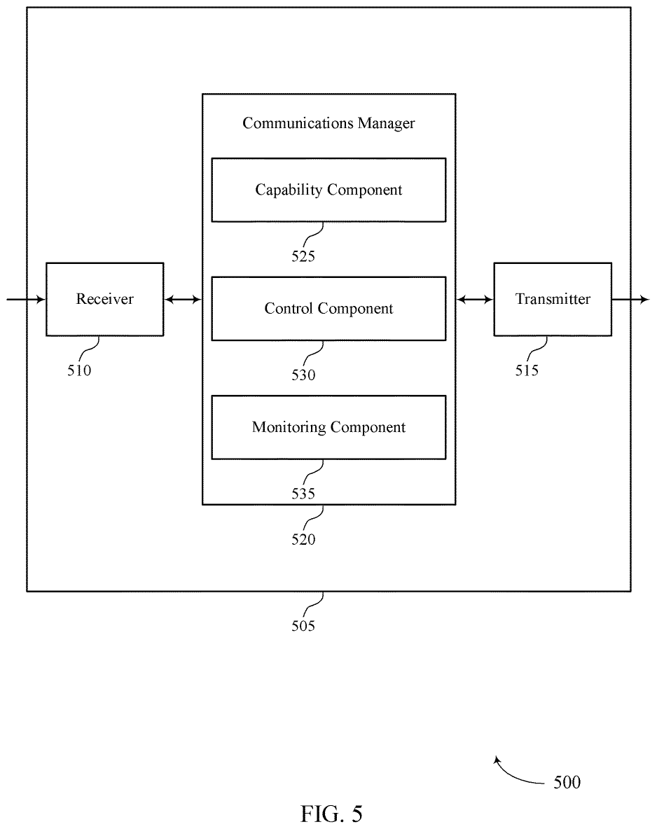

FIG. 5 shows a block diagram 500 of a device 505 that supports UE beam capabilities given beam configurations in predictive beam management in accordance with one or more aspects of the present disclosure. The device 505 may be an example of aspects of a device 405 or a first network node 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to UE beam capabilities given beam configurations in predictive beam management). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to UE beam capabilities given beam configurations in predictive beam management). In some aspects, the transmitter 515 may be co-located with a receiver 510 in a transceiver module. The transmitter 515 may utilize a single antenna or a set of multiple antennas.

The device 505, or various components thereof, may be an example of means for performing various aspects of UE beam capabilities given beam configurations in predictive beam management as described herein. For example, the communications manager 520 may include a capability component 525, a control component 530, a monitoring component 535, or any combination thereof. The communications manager 520 may be an example of aspects of a communications manager 420 as described herein. In some aspects, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a first network node in accordance with examples as disclosed herein. The capability component 525 may be configured as or otherwise support a means for transmitting capability information including information indicative of at least one of: a first quantity of beams for which the first network node is capable of generating beam predictions or a first type of beam for which the first network node is capable of generating the beam predictions, where the information is based on a quantity of available reference signal resources or a type of available reference signal resources for beam prediction. The control component 530 may be configured as or otherwise support a means for receiving, based on the capability information, control information including information indicative of a quantity of reference signal resources or a type of reference signal resources to use as measurement resources for beam prediction, and information indicative of a quantity of beams or a beam type to monitor as beam prediction targets. The monitoring component 535 may be configured as or otherwise support a means for monitoring the measurement resources in accordance with the quantity of beams or the beam type indicated by the control information.

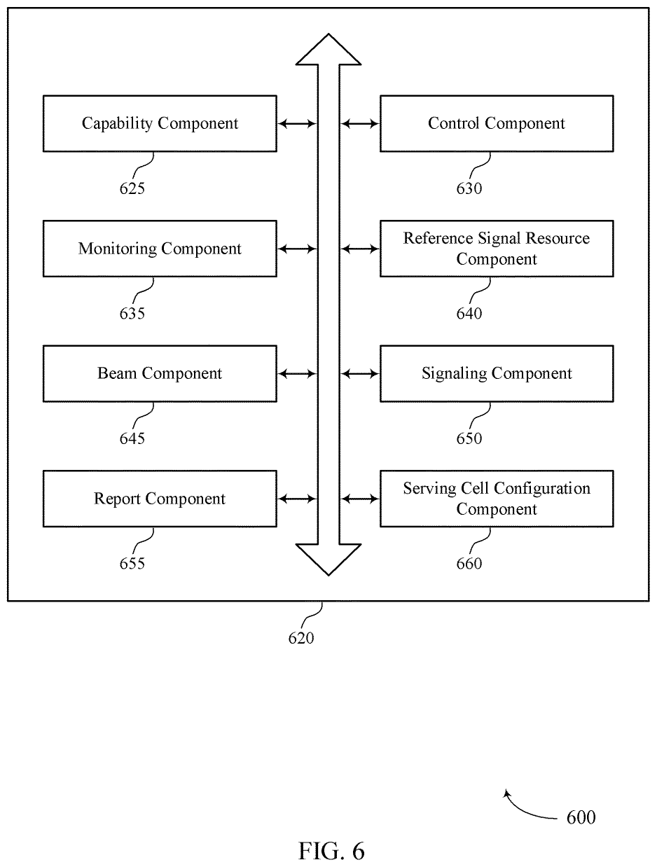

FIG. 6 shows a block diagram 600 of a communications manager 620 that supports UE beam capabilities given beam configurations in predictive beam management in accordance with one or more aspects of the present disclosure. The communications manager 620 may be an example of aspects of a communications manager 420, a communications manager 520, or both, as described herein. The communications manager 620, or various components thereof, may be an example of means for performing various aspects of UE beam capabilities given beam configurations in predictive beam management as described herein. For example, the communications manager 620 may include a capability component 625, a control component 630, a monitoring component 635, a reference signal resource component 640, a beam component 645, a signaling component 650, a report component 655, a serving cell configuration component 660, or any combination thereof. Each of these components may communicate, directly or indirectly, with one another (e.g., via one or more buses).

The communications manager 620 may support wireless communication at a first network node in accordance with examples as disclosed herein. The capability component 625 may be configured as or otherwise support a means for transmitting capability information including information indicative of at least one of: a first quantity of beams for which the first network node is capable of generating beam predictions or a first type of beam for which the first network node is capable of generating the beam predictions, where the information is based on a quantity of available reference signal resources or a type of available reference signal resources for beam prediction. The control component 630 may be configured as or otherwise support a means for receiving, based on the capability information, control information including information indicative of a quantity of reference signal resources or a type of reference signal resources to use as measurement resources for beam prediction, and information indicative of a quantity of beams or a beam type to monitor as beam prediction targets. The monitoring component 635 may be configured as or otherwise support a means for monitoring the measurement resources in accordance with the quantity of beams or the beam type indicated by the control information.

In some aspects, the control information includes the information indicative of the type of reference signal resources, where the information indicative of the type of reference signal resources identifies a reference signal resource periodicity.

In some aspects, the control information includes the information indicative of the type of reference signal resources, where the information indicative of the type of reference signal resources identifies that the type of reference signal resources is associated with single-port CSI-RS transmission, or is associated with multi-port CSI-RS transmission.

In some aspects, the control information includes the information indicative of the type of reference signal resources, where the information indicative of the type of reference signal resources identifies that the type of reference signal resources is associated with SSB transmission.

In some aspects, the capability information includes the information indicative of the first type of beam, where the information indicative of the first type of beam identifies whether the first type of beam for which the first network node is capable of generating the beam predictions includes a beam communicated via reference signal resources configured as the measurement resources.

In some aspects, the capability information includes the information indicative of the first type of beam, where the information indicative of the first type of beam identifies a periodicity associated with the first type of beam for which the first network node is capable of generating the beam predictions.

In some aspects, the capability information includes the information indicative of the first type of beam, where the information indicative of the first type of beam identifies a quantity of future time domain occasions for which the first network node is capable of generating the beam predictions, a time interval between adjacent future time domain occasions for the beam prediction, or both.

In some aspects, the signaling component 650 may be configured as or otherwise support a means for receiving signaling indicating a set of combinations of quantities of available reference signal resources and types of available reference signal resources to use as the measurement resources for the beam prediction.

In some aspects, the capability information includes the information indicative the first quantity of beams or the first type of beam for which the first network node is capable of generating the beam predictions, where the information is based on the set of combinations of quantities of available reference signal resources and types of available reference signal resources indicated by the signaling.

In some aspects, to support transmitting the capability information, the capability component 625 may be configured as or otherwise support a means for transmitting the capability information based on a type of report in which the first network node is capable of transmitting beam prediction results.

In some aspects, to support receiving the control information, the capability component 625 may be configured as or otherwise support a means for receiving the control information based on a type of report in which the first network node is capable of transmitting beam prediction results.

In some aspects, the report component 655 may be configured as or otherwise support a means for transmit a report including one or more beam prediction results based on the monitored measurement resources.

In some aspects, to support transmitting the capability information, the capability component 625 may be configured as or otherwise support a means for transmit the capability information during an initial access procedure.

In some aspects, the serving cell configuration component 660 may be configured as or otherwise support a means for receiving a serving cell configuration for the first network node. In some aspects, the serving cell configuration component 660 may be configured as or otherwise support a means for transmitting, based on the serving cell configuration, the capability information.

In some aspects, the quantity of reference signal resources is associated with the quantity of available reference signal resources and the type of reference signal resources is associated with the type of available reference signal resources.

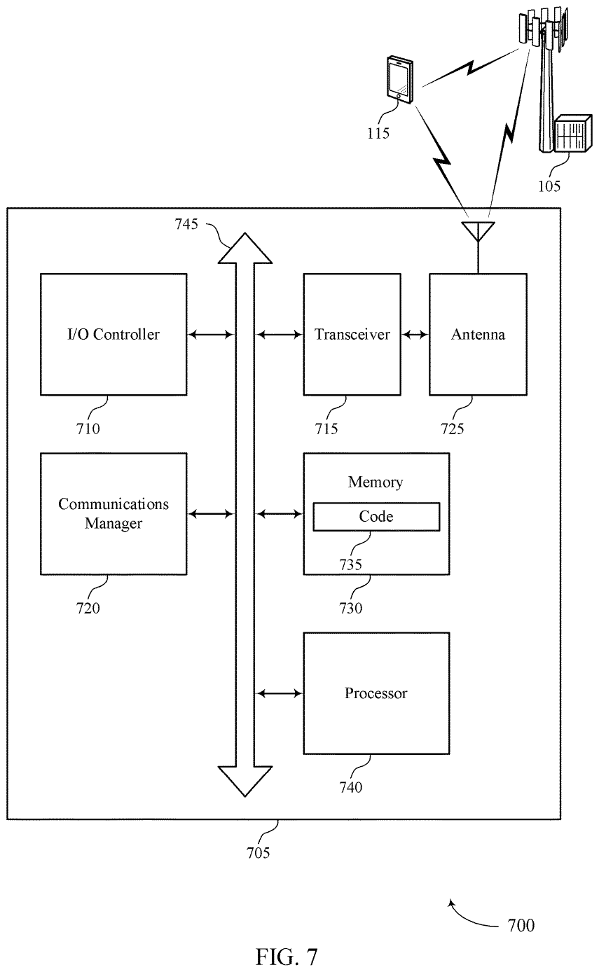

FIG. 7 shows a diagram of a system 700 including a device 705 that supports UE beam capabilities given beam configurations in predictive beam management in accordance with one or more aspects of the present disclosure. The device 705 may be an example of or include the components of a device 405, a device 505, or a first network node as described herein. The device 705 may include components for bi-directional voice and data communications including components for transmitting and receiving communications, such as a communications manager 720, an I/O controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include RAM and ROM. The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a BIOS which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting UE beam capabilities given beam configurations in predictive beam management). For example, the device 705 or a component of the device 705 may include a processor 740 and memory 730 coupled with or to the processor 740, the processor 740 and memory 730 configured to perform various functions described herein.

The communications manager 720 may support wireless communication at a first network node in accordance with examples as disclosed herein. For example, the communications manager 720 may be configured as or otherwise support a means for transmitting capability information including information indicative of at least one of: a first quantity of beams for which the first network node is capable of generating beam predictions or a first type of beam for which the first network node is capable of generating the beam predictions, where the information is based on a quantity of available reference signal resources or a type of available reference signal resources for beam prediction. The communications manager 720 may be configured as or otherwise support a means for receiving, based on the capability information, control information including information indicative of a quantity of reference signal resources or a type of reference signal resources to use as measurement resources for beam prediction, and information indicative of a quantity of beams or a beam type to monitor as beam prediction targets. The communications manager 720 may be configured as or otherwise support a means for monitoring the measurement resources in accordance with the quantity of beams or the beam type indicated by the control information.

By including or configuring the communications manager 720 in accordance with examples as described herein, the device 705 may support techniques for reporting beam capabilities based on beam configurations, which may increase signaling efficiency, reduce overhead and power consumption, and improve communications between wireless devices.

In some aspects, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some aspects, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of UE beam capabilities given beam configurations in predictive beam management as described herein, or the processor 740 and the memory 730 may be otherwise configured to perform or support such operations.

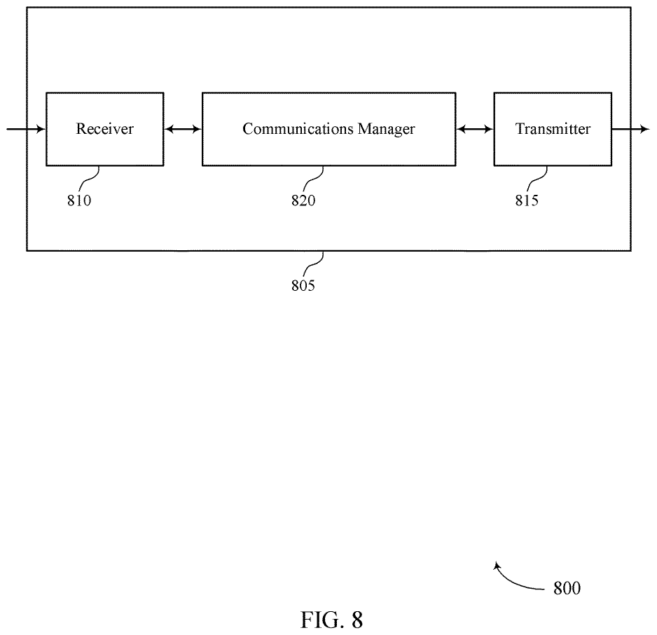

FIG. 8 shows a block diagram 800 of a device 805 that supports UE beam capabilities given beam configurations in predictive beam management in accordance with one or more aspects of the present disclosure. The device 805 may be an example of aspects of a second network node as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some aspects, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some aspects, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of UE beam capabilities given beam configurations in predictive beam management as described herein. For example, the communications manager 820, the receiver 810, the transmitter 815, or various combinations or components thereof may support a method for performing one or more of the functions described herein.

In some aspects, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a second network node in accordance with examples as disclosed herein. For example, the communications manager 820 may be configured as or otherwise support a means for receiving capability information including information indicative of at least one of: a first quantity of beams for which a first network node is capable of generating beam predictions or a first type of beam for which the first network node is capable of generating the beam predictions, where the information is based on a quantity of available reference signal resources or a type of available reference signal resources for beam prediction. The communications manager 820 may be configured as or otherwise support a means for transmitting, based on the capability information, control information including information indicative of a quantity of reference signal resources or a type of reference signal resources as measurement resources for beam prediction, and information indicative of a quantity of beams or a beam type to monitor as beam prediction targets. The communications manager 820 may be configured as or otherwise support a means for transmitting the measurement resources in accordance with the quantity of beams or the beam type indicated by the control information.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reporting beam capabilities based on beam configurations, which may increase signaling efficiency, reduce overhead and power consumption, and improve communications between wireless devices.

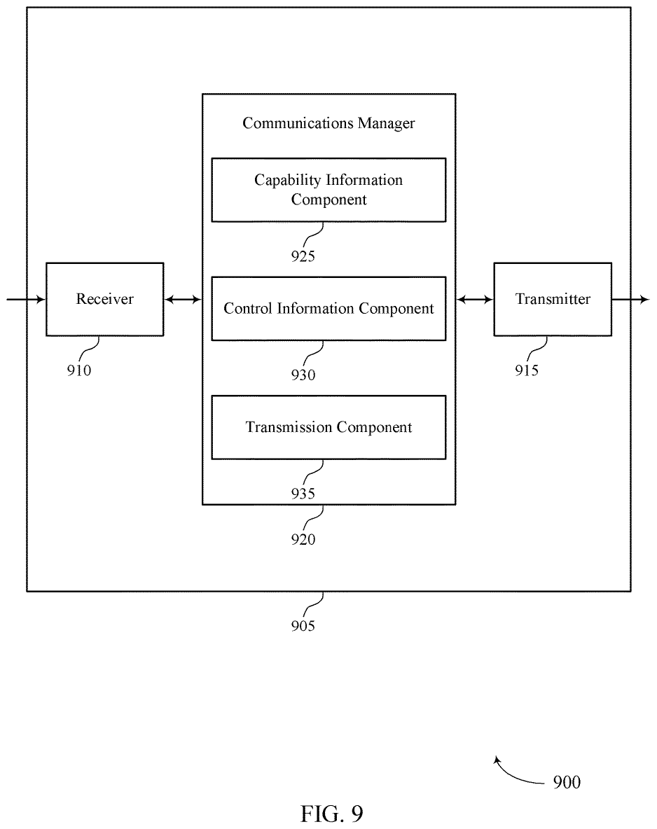

FIG. 9 shows a block diagram 900 of a device 905 that supports UE beam capabilities given beam configurations in predictive beam management in accordance with one or more aspects of the present disclosure. The device 905 may be an example of aspects of a device 805 or a second network node 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some aspects, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some aspects, the transmitter 915 and the receiver 910 may be co-located in a transceiver, which may include or be coupled with a modem.

The device 905, or various components thereof, may be an example of means for performing various aspects of UE beam capabilities given beam configurations in predictive beam management as described herein. For example, the communications manager 920 may include a capability information component 925, a control information component 930, a transmission component 935, or any combination thereof. The communications manager 920 may be an example of aspects of a communications manager 820 as described herein. In some aspects, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a second network node in accordance with examples as disclosed herein. The capability information component 925 may be configured as or otherwise support a means for receiving capability information including information indicative of at least one of: a first quantity of beams for which a first network node is capable of generating beam predictions or a first type of beam for which the first network node is capable of generating the beam predictions, where the information is based on a quantity of available reference signal resources or a type of available reference signal resources for beam prediction. The control information component 930 may be configured as or otherwise support a means for transmitting, based on the capability information, control information including information indicative of a quantity of reference signal resources or a type of reference signal resources as measurement resources for beam prediction, and information indicative of a quantity of beams or a beam type to monitor as beam prediction targets. The transmission component 935 may be configured as or otherwise support a means for transmitting the measurement resources in accordance with the quantity of beams or the beam type indicated by the control information.

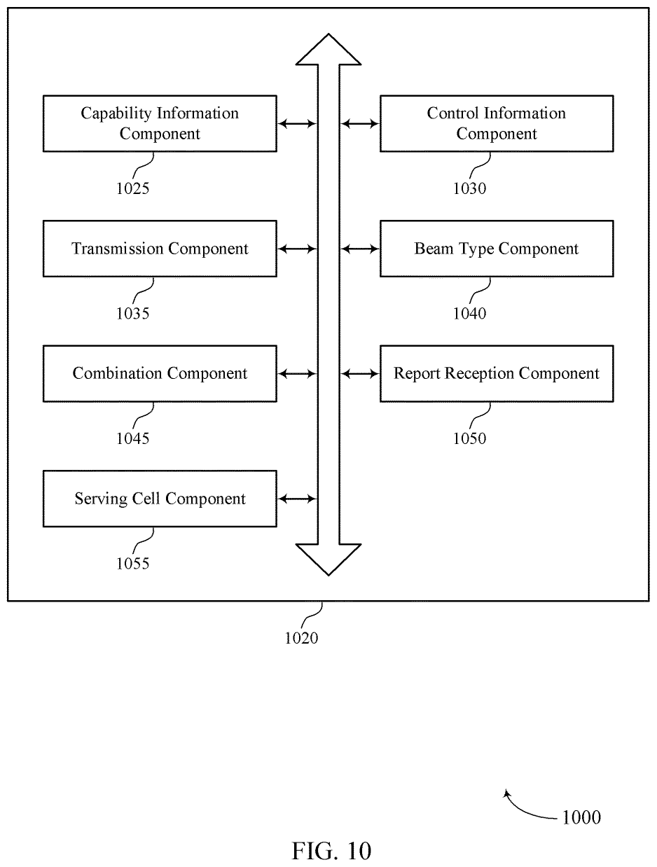

FIG. 10 shows a block diagram 1000 of a communications manager 1020 that supports UE beam capabilities given beam configurations in predictive beam management in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of UE beam capabilities given beam configurations in predictive beam management as described herein. For example, the communications manager 1020 may include a capability information component 1025, a control information component 1030, a transmission component 1035, a beam type component 1040, a combination component 1045, a report reception component 1050, a serving cell component 1055, or any combination thereof. Each of these components may communicate, directly or indirectly, with one another (e.g., via one or more buses).

The communications manager 1020 may support wireless communication at a second network node in accordance with examples as disclosed herein. The capability information component 1025 may be configured as or otherwise support a means for receiving capability information including information indicative of at least one of: a first quantity of beams for which a first network node is capable of generating beam predictions or a first type of beam for which the first network node is capable of generating the beam predictions, where the information is based on a quantity of available reference signal resources or a type of available reference signal resources for beam prediction. The control information component 1030 may be configured as or otherwise support a means for transmitting, based on the capability information, control information including information indicative of a quantity of reference signal resources or a type of reference signal resources as measurement resources for beam prediction, and information indicative of a quantity of beams or a beam type to monitor as beam prediction targets. The transmission component 1035 may be configured as or otherwise support a means for transmitting the measurement resources in accordance with the quantity of beams or the beam type indicated by the control information.

In some aspects, the control information includes the information indicative of the type of reference signal resources, where the information indicative of the type of reference signal resources identifies a reference signal resource periodicity.

In some aspects, the control information includes the information indicative the type of reference signal resources, where the information indicative of the type of reference signal resources identifies that the type of reference signal resources is associated with single-port CSI-RS transmission, or is associated with multi-port CSI-RS transmission.

In some aspects, the control information includes the information indicative of the type of reference signal resources, where the information indicative of the type of reference signal resources identifies that the type of reference signal resources is associated with SSB transmission.

In some aspects, the capability information includes the information indicative of the first type of beam, where the information indicative of the first type of beam identifies whether the first type of beam for which the first network node is capable of generating the beam prediction includes a beam communicated via reference signal resources configured as the measurement resources.

In some aspects, the capability information includes the information indicative of the first type of beam, where the information indicative of the first type of beam identifies a periodicity associated with the first type of beam for which the first network node is capable of generating the beam predictions.

In some aspects, the capability information includes the information indicative of the first type of beam, where the information indicative of the first type of beam identifies a quantity of future time domain occasions for which the first network node is capable of generating the beam predictions, a time interval between adjacent future time domain occasions for the beam prediction, or both.

In some aspects, the combination component 1045 may be configured as or otherwise support a means for transmitting signaling indicating a set of combinations of quantities of available reference signal resources and types of available reference signal resources to use as the measurement resources for the beam prediction.

In some aspects, the capability information includes the information indicative of the first quantity of beams or the first type of beam for which the first network node is capable of generating the beam predictions, where the information is based on the set of combinations of available quantities of reference signal resources and available types of reference signal resources indicated by the signaling.

In some aspects, to support receiving the capability information, the capability information component 1025 may be configured as or otherwise support a means for receiving the capability information based on a type of report in which the first network node is capable of transmitting beam prediction results.

In some aspects, to support transmitting the control information, the capability information component 1025 may be configured as or otherwise support a means for transmitting the control information based on a type of report in which the first network node is capable of transmitting beam prediction results.

In some aspects, the report reception component 1050 may be configured as or otherwise support a means for receiving a report including one or more beam prediction results based on the transmitted measurement resources.

In some aspects, to support receiving the capability information, the report reception component 1050 may be configured as or otherwise support a means for receiving the capability information during an initial access procedure.

In some aspects, the serving cell component 1055 may be configured as or otherwise support a means for transmitting a serving cell configuration for the first network node. In some aspects, the serving cell component 1055 may be configured as or otherwise support a means for receiving, based on the serving cell configuration, the capability information.

In some aspects, the quantity of reference signal resources is associated with the quantity of available reference signal resources and the type of reference signal resources is associated with the type of available reference signal resources.

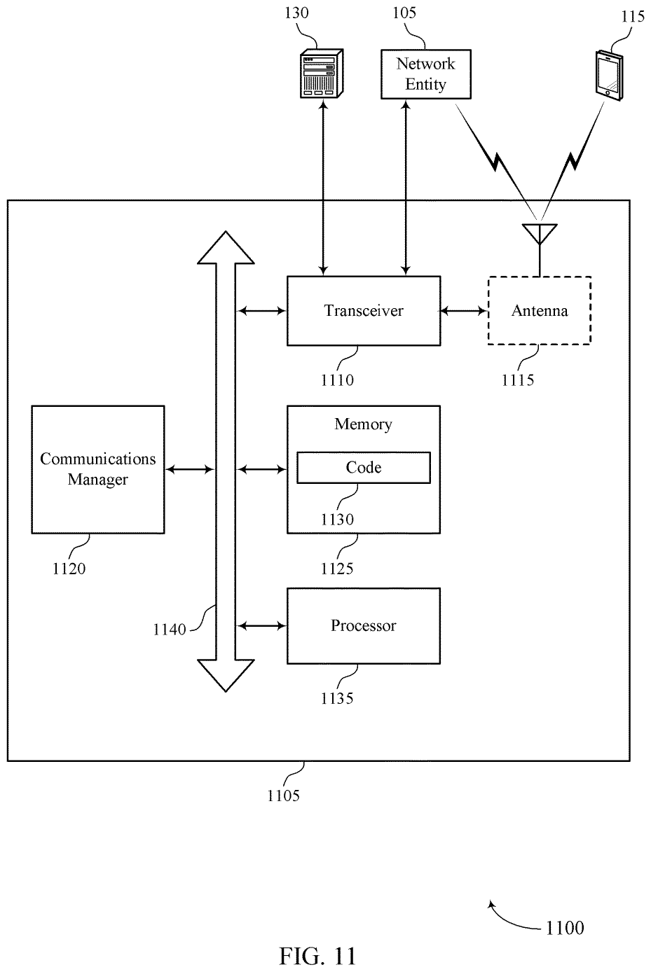

FIG. 11 shows a diagram of a system 1100 including a device 1105 that supports UE beam capabilities given beam configurations in predictive beam management in accordance with one or more aspects of the present disclosure. The device 1105 may be an example of or include the components of a device 805, a device 905, or a second network node as described herein. The device 1105 may include components for bi-directional voice and data communications including components for transmitting and receiving communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some aspects, the transceiver 1110 may include a wired transceiver and may communicate bi-directionally with another wired transceiver. Additionally, or alternatively, in some aspects, the transceiver 1110 may include a wireless transceiver and may communicate bi-directionally with another wireless transceiver. In some aspects, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some aspects, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting UE beam capabilities given beam configurations in predictive beam management). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some aspects, a bus 1140 may support communications of (e.g., within) a protocol layer of a protocol stack. In some aspects, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some aspects, the communications manager 1120 may manage aspects of communications with a core network 130 (e.g., via one or more wired or wireless backhaul links). For example, the communications manager 1120 may manage the transfer of data communications for client devices, such as one or more UEs 115. In some aspects, the communications manager 1120 may manage communications with other network entities 105, and may include a controller or scheduler for controlling communications with UEs 115 in cooperation with other network entities 105. In some aspects, the communications manager 1120 may support an X2 interface within an LTE/LTE-A wireless communications network technology to provide communication between network entities 105.

The communications manager 1120 may support wireless communication at a second network node in accordance with examples as disclosed herein. For example, the communications manager 1120 may be configured as or otherwise support a means for receiving capability information including information indicative of at least one of: a first quantity of beams for which a first network node is capable of generating beam predictions or a first type of beam for which the first network node is capable of generating the beam predictions, where the information is based on a quantity of available reference signal resources or a type of available reference signal resources for beam prediction. The communications manager 1120 may be configured as or otherwise support a means for transmitting, based on the capability information, control information including information indicative of a quantity of reference signal resources or a type of reference signal resources as measurement resources for beam prediction, and information indicative of a quantity of beams or a beam type to monitor as beam prediction targets. The communications manager 1120 may be configured as or otherwise support a means for transmitting the measurement resources in accordance with the quantity of beams or the beam type indicated by the control information.

By including or configuring the communications manager 1120 in accordance with examples as described herein, the device 1105 may support techniques for reporting beam capabilities based on beam configurations, which may increase signaling efficiency, reduce overhead and power consumption, and improve communications between wireless devices.

In some aspects, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some aspects, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of UE beam capabilities given beam configurations in predictive beam management as described herein, or the processor 1135 and the memory 1125 may be otherwise configured to perform or support such operations.

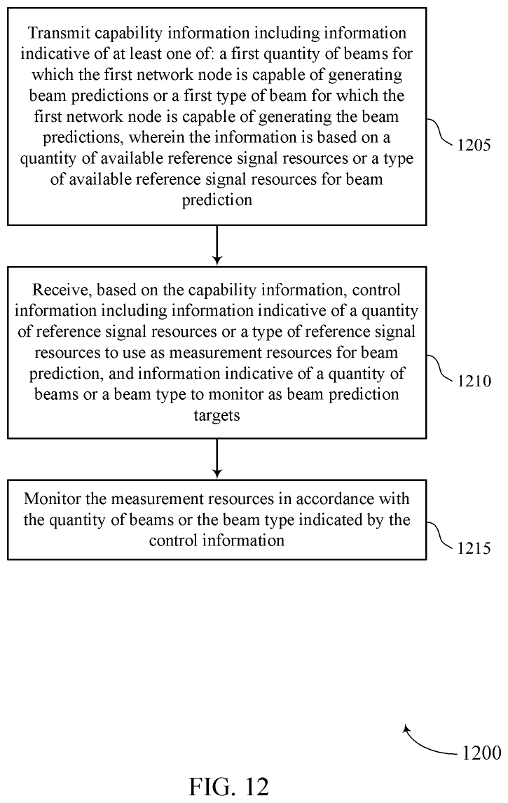

FIG. 12 shows a flowchart illustrating a method 1200 that supports UE beam capabilities given beam configurations in predictive beam management in accordance with one or more aspects of the present disclosure. The operations of the method 1200 may be implemented by a first network node or its components as described herein. For example, the operations of the method 1200 may be performed by a first network node as described with reference to FIGS. 1 through 7. In some aspects, a first network node may execute a set of instructions to control the functional elements of the first network node to perform the described functions. Additionally, or alternatively, the first network node may perform aspects of the described functions using special-purpose hardware.

At 1205, the method may include transmitting capability information including information indicative of at least one of: a first quantity of beams for which the first network node is capable of generating beam predictions or a first type of beam for which the first network node is capable of generating the beam predictions, where the information is based on a quantity of available reference signal resources or a type of available reference signal resources for beam prediction. The operations of 1205 may be performed in accordance with examples as disclosed herein. In some aspects, aspects of the operations of 1205 may be performed by a capability component 625 as described with reference to FIG. 6.

At 1210, the method may include receiving, based on the capability information, control information including information indicative of a quantity of reference signal resources or a type of reference signal resources to use as measurement resources for beam prediction, and information indicative of a quantity of beams or a beam type to monitor as beam prediction targets. The operations of 1210 may be performed in accordance with examples as disclosed herein. In some aspects, aspects of the operations of 1210 may be performed by a control component 630 as described with reference to FIG. 6.

At 1215, the method may include monitoring the measurement resources in accordance with the quantity of beams or the beam type indicated by the control information. The operations of 1215 may be performed in accordance with examples as disclosed herein. In some aspects, aspects of the operations of 1215 may be performed by a monitoring component 635 as described with reference to FIG. 6.

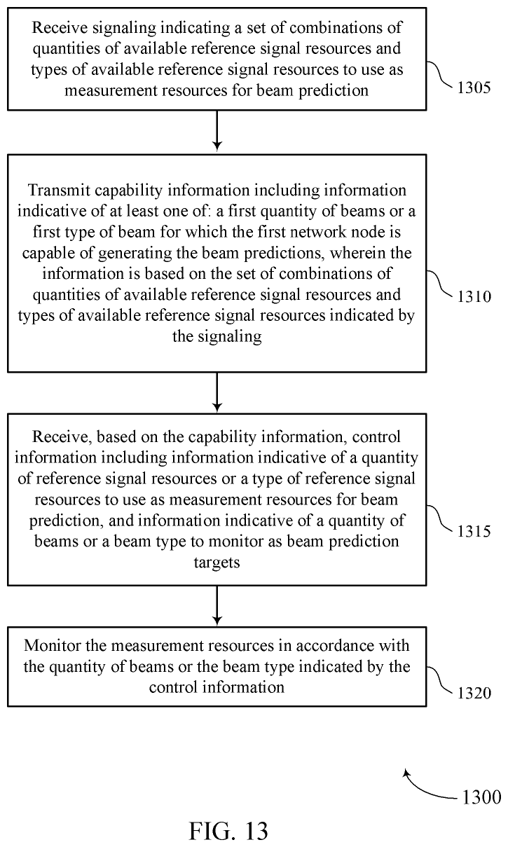

FIG. 13 shows a flowchart illustrating a method 1300 that supports UE beam capabilities given beam configurations in predictive beam management in accordance with one or more aspects of the present disclosure. The operations of the method 1300 may be implemented by a first network node or its components as described herein. For example, the operations of the method 1300 may be performed by a first network node as described with reference to FIGS. 1 through 7. In some aspects, a first network node may execute a set of instructions to control the functional elements of the first network node to perform the described functions. Additionally, or alternatively, the first network node may perform aspects of the described functions using special-purpose hardware.

At 1305, the method may include receiving signaling indicating a set of combinations of quantities of available reference signal resources and types of available reference signal resources to use as measurement resources for beam prediction. The operations of 1305 may be performed in accordance with examples as disclosed herein. In some aspects, aspects of the operations of 1305 may be performed by a signaling component 650 as described with reference to FIG. 6.

At 1310, the method may include transmitting capability information including information indicative of at least one of: a first quantity of beams or a first type of beam for which the first network node is capable of generating the beam predictions, where the information is based on the set of combinations of quantities of available reference signal resources and types of available reference signal resources indicated by the signaling. The operations of 1310 may be performed in accordance with examples as disclosed herein. In some aspects, aspects of the operations of 1310 may be performed by a capability component 625 as described with reference to FIG. 6.

At 1315, the method may include receiving, based on the capability information, control information including information indicative of a quantity of reference signal resources or a type of reference signal resources to use as measurement resources for beam prediction, and information indicative of a quantity of beams or a beam type to monitor as beam prediction targets. The operations of 1315 may be performed in accordance with examples as disclosed herein. In some aspects, aspects of the operations of 1315 may be performed by a control component 630 as described with reference to FIG. 6.

At 1320, the method may include monitoring the measurement resources in accordance with the quantity of beams or the beam type indicated by the control information. The operations of 1320 may be performed in accordance with examples as disclosed herein. In some aspects, aspects of the operations of 1320 may be performed by a monitoring component 635 as described with reference to FIG. 6.

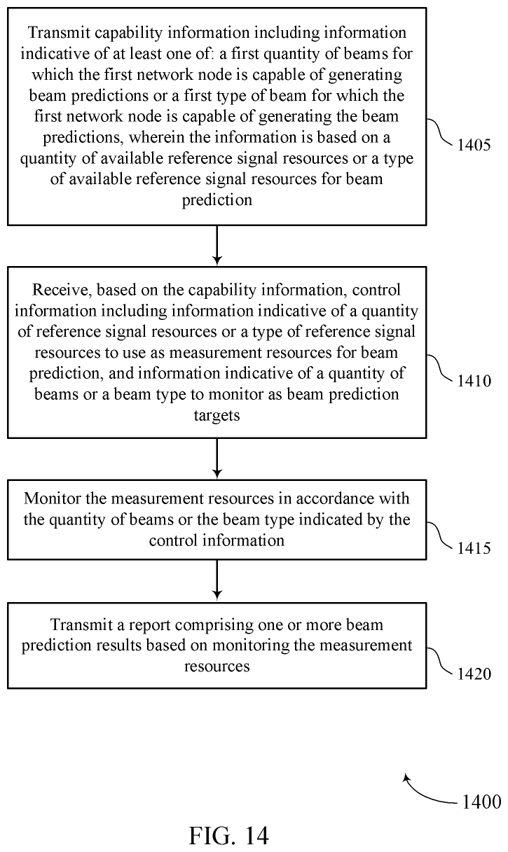

FIG. 14 shows a flowchart illustrating a method 1400 that supports UE beam capabilities given beam configurations in predictive beam management in accordance with one or more aspects of the present disclosure. The operations of the method 1400 may be implemented by a first network node or its components as described herein. For example, the operations of the method 1400 may be performed by a first network node as described with reference to FIGS. 1 through 7. In some aspects, a first network node may execute a set of instructions to control the functional elements of the first network node to perform the described functions. Additionally, or alternatively, the first network node may perform aspects of the described functions using special-purpose hardware.

At 1405, the method may include transmitting capability information including information indicative of at least one of: a first quantity of beams for which the first network node is capable of generating beam predictions or a first type of beam for which the first network node is capable of generating the beam predictions, where the information is based on a quantity of available reference signal resources or a type of available reference signal resources for beam prediction. The operations of 1405 may be performed in accordance with examples as disclosed herein. In some aspects, aspects of the operations of 1405 may be performed by a capability component 625 as described with reference to FIG. 6.

At 1410, the method may include receiving, based on the capability information, control information including information indicative of a quantity of reference signal resources or a type of reference signal resources to use as measurement resources for beam prediction, and information indicative of a quantity of beams or a beam type to monitor as beam prediction targets. The operations of 1410 may be performed in accordance with examples as disclosed herein. In some aspects, aspects of the operations of 1410 may be performed by a control component 630 as described with reference to FIG. 6.

At 1415, the method may include monitoring the measurement resources in accordance with the quantity of beams or the beam type indicated by the control information. The operations of 1415 may be performed in accordance with examples as disclosed herein. In some aspects, aspects of the operations of 1415 may be performed by a monitoring component 635 as described with reference to FIG. 6.

At 1420, the method may include transmit a report including one or more beam prediction results based on the monitored measurement resources. The operations of 1420 may be performed in accordance with examples as disclosed herein. In some aspects, aspects of the operations of 1420 may be performed by a report component 655 as described with reference to FIG. 6.

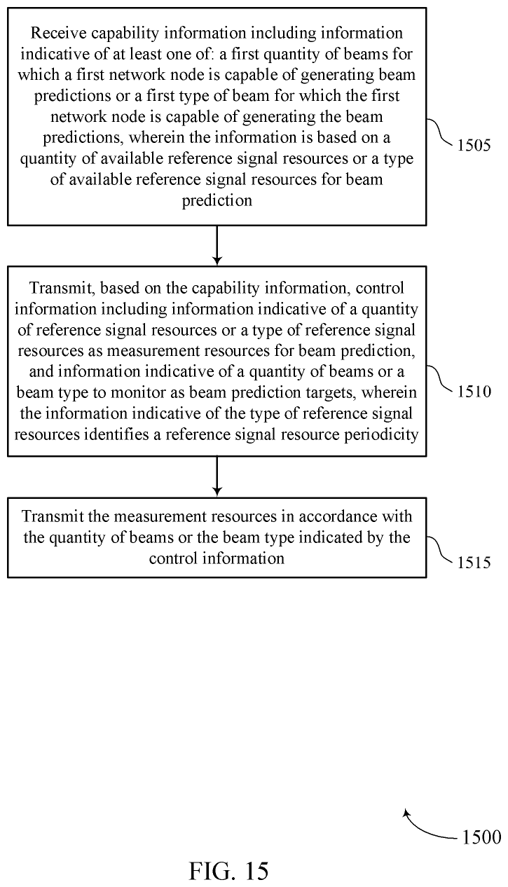

FIG. 15 shows a flowchart illustrating a method 1500 that supports UE beam capabilities given beam configurations in predictive beam management in accordance with one or more aspects of the present disclosure. The operations of the method 1500 may be implemented by a second network node or its components as described herein. For example, the operations of the method 1500 may be performed by a second network node as described with reference to FIGS. 1 through 3 and 8 through 11. In some aspects, a second network node may execute a set of instructions to control the functional elements of the second network node to perform the described functions. Additionally, or alternatively, the second network node may perform aspects of the described functions using special-purpose hardware.

At 1505, the method may include receiving capability information including information indicative of at least one of: a first quantity of beams for which a first network node is capable of generating beam predictions or a first type of beam for which the first network node is capable of generating the beam predictions, where the information is based on a quantity of available reference signal resources or a type of available reference signal resources for beam prediction. The operations of 1505 may be performed in accordance with examples as disclosed herein. In some aspects, aspects of the operations of 1505 may be performed by a capability information component 1025 as described with reference to FIG. 10.

At 1510, the method may include transmitting, based on the capability information, control information including information indicative of a quantity of reference signal resources or a type of reference signal resources as measurement resources for beam prediction, and information indicative of a quantity of beams or a beam type to monitor as beam prediction targets, where the information indicative of the type of reference signal resources identifies a reference signal resource periodicity. The operations of 1510 may be performed in accordance with examples as disclosed herein. In some aspects, aspects of the operations of 1510 may be performed by a control information component 1030 as described with reference to FIG. 10.

At 1515, the method may include transmitting the measurement resources in accordance with the quantity of beams or the beam type indicated by the control information. The operations of 1515 may be performed in accordance with examples as disclosed herein. In some aspects, aspects of the operations of 1515 may be performed by a transmission component 1035 as described with reference to FIG. 10.

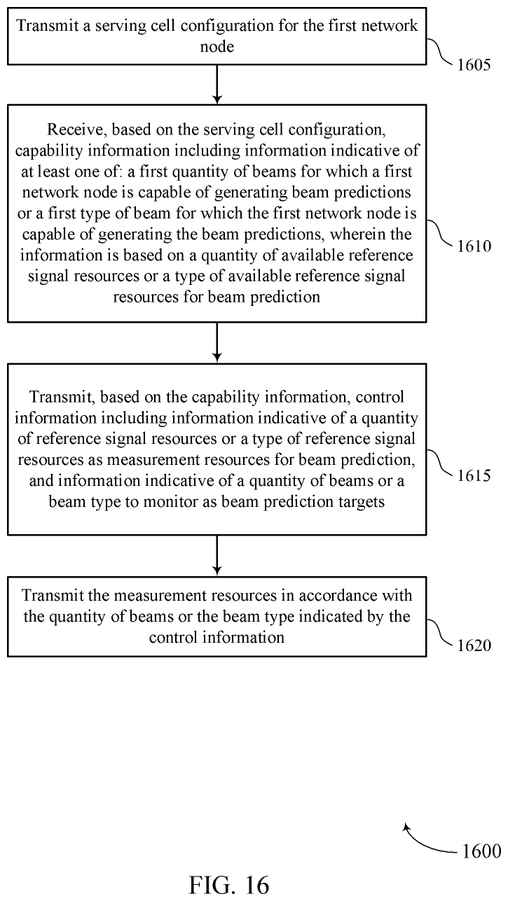

FIG. 16 shows a flowchart illustrating a method 1600 that supports UE beam capabilities given beam configurations in predictive beam management in accordance with one or more aspects of the present disclosure. The operations of the method 1600 may be implemented by a second network node or its components as described herein. For example, the operations of the method 1600 may be performed by a second network node as described with reference to FIGS. 1 through 3 and 8 through 11. In some aspects, a second network node may execute a set of instructions to control the functional elements of the second network node to perform the described functions. Additionally, or alternatively, the second network node may perform aspects of the described functions using special-purpose hardware.

At 1605, the method may include transmitting a serving cell configuration for the first network node. The operations of 1605 may be performed in accordance with examples as disclosed herein. In some aspects, aspects of the operations of 1605 may be performed by a serving cell component 1055 as described with reference to FIG. 10.

At 1610, the method may include receiving, based on the serving cell configuration, capability information including information indicative of at least one of: a first quantity of beams for which a first network node is capable of generating beam predictions or a first type of beam for which the first network node is capable of generating the beam predictions, where the information is based on a quantity of available reference signal resources or a type of available reference signal resources for beam prediction. The operations of 1610 may be performed in accordance with examples as disclosed herein. In some aspects, aspects of the operations of 1610 may be performed by a capability information component 1025 as described with reference to FIG. 10.

At 1615, the method may include transmitting, based on the capability information, control information including information indicative of a quantity of reference signal resources or a type of reference signal resources as measurement resources for beam prediction, and information indicative of a quantity of beams or a beam type to monitor as beam prediction targets. The operations of 1615 may be performed in accordance with examples as disclosed herein. In some aspects, aspects of the operations of 1615 may be performed by a control information component 1030 as described with reference to FIG. 10.

At 1620, the method may include transmitting the measurement resources in accordance with the quantity of beams or the beam type indicated by the control information. The operations of 1620 may be performed in accordance with examples as disclosed herein. In some aspects, aspects of the operations of 1620 may be performed by a transmission component 1035 as described with reference to FIG. 10.

The following provides an overview of aspects of the present disclosure:

Aspect 1: A method for wireless communication at a first network node, comprising: transmitting capability information including information indicative of at least one of: a first quantity of beams for which the first network node is capable of generating beam predictions or a first type of beam for which the first network node is capable of generating the beam predictions, wherein the information is based on a quantity of available reference signal resources or a type of available reference signal resources for beam prediction; receiving, based on the capability information, control information including information indicative of a quantity of reference signal resources or a type of reference signal resources to use as measurement resources for beam prediction, and information indicative of a quantity of beams or a beam type to monitor as beam prediction targets; and monitoring the measurement resources in accordance with the quantity of beams or the beam type indicated by the control information.

Aspect 2: The method of aspect 1, wherein the control information includes the information indicative of the type of reference signal resources, wherein the information indicative of the type of reference signal resources identifies a reference signal resource periodicity.

Aspect 3: The method of any of aspects 1 through 2, wherein the control information includes the information indicative of the type of reference signal resources, wherein the information indicative of the type of reference signal resources identifies that the type of reference signal resources is associated with single-port CSI-RS transmission, or is associated with multi-port CSI-RS transmission.

Aspect 4: The method of any of aspects 1 through 3, wherein the control information includes the information indicative of the type of reference signal resources, wherein the information indicative of the type of reference signal resources identifies that the type of reference signal resources is associated with SSB transmission.

Aspect 5: The method of any of aspects 1 through 4, wherein the capability information includes the information indicative of the first type of beam, wherein the information indicative of the first type of beam identifies whether the first type of beam for which the first network node is capable of generating the beam predictions includes a beam communicated via reference signal resources configured as the measurement resources.

Aspect 6: The method of any of aspects 1 through 5, wherein the capability information includes the information indicative of the first type of beam, wherein the information indicative of the first type of beam identifies a periodicity associated with the first type of beam for which the first network node is capable of generating the beam predictions.

Aspect 7: The method of any of aspects 1 through 6, wherein the capability information includes the information indicative of the first type of beam, wherein the information indicative of the first type of beam identifies a quantity of future time domain occasions for which the first network node is capable of generating the beam predictions, a time interval between adjacent future time domain occasions for the beam prediction, or both.

Aspect 8: The method of any of aspects 1 through 7, further comprising: receiving signaling indicating a set of combinations of quantities of available reference signal resources and types of available reference signal resources to use as the measurement resources for the beam prediction.

Aspect 9: The method of aspect 8, wherein the capability information includes the information indicative the first quantity of beams or the first type of beam for which the first network node is capable of generating the beam predictions, wherein the information is based on the set of combinations of quantities of available reference signal resources and types of available reference signal resources indicated by the signaling.

Aspect 10: The method of any of aspects 1 through 9, wherein transmitting the capability information comprises: transmitting the capability information based on a type of report in which the first network node is capable of transmitting beam prediction results.

Aspect 11: The method of any of aspects 1 through 10, wherein receiving the control information comprises: receiving the control information based on a type of report in which the first network node is capable of transmitting beam prediction results.

Aspect 12: The method of any of aspects 1 through 11, further comprising: transmit a report comprising one or more beam prediction results based on the monitored measurement resources.

Aspect 13: The method of any of aspects 1 through 12, wherein transmitting the capability information comprises: transmit the capability information during an initial access procedure.

Aspect 14: The method of any of aspects 1 through 13, further comprising: receiving a serving cell configuration for the first network node; and transmitting, based on the serving cell configuration, the capability information.

Aspect 15: The method of any of aspects 1 through 14, wherein the quantity of reference signal resources is associated with the quantity of available reference signal resources and the type of reference signal resources is associated with the type of available reference signal resources.

Aspect 16: A method for wireless communication at a second network node, comprising: receiving capability information including information indicative of at least one of: a first quantity of beams for which a first network node is capable of generating beam predictions or a first type of beam for which the first network node is capable of generating the beam predictions, wherein the information is based on a quantity of available reference signal resources or a type of available reference signal resources for beam prediction; transmitting, based on the capability information, control information including information indicative of a quantity of reference signal resources or a type of reference signal resources as measurement resources for beam prediction, and information indicative of a quantity of beams or a beam type to monitor as beam prediction targets; and transmitting the measurement resources in accordance with the quantity of beams or the beam type indicated by the control information.

Aspect 17: The method of aspect 16, wherein the control information includes the information indicative of the type of reference signal resources, wherein the information indicative of the type of reference signal resources identifies a reference signal resource periodicity.

Aspect 18: The method of any of aspects 16 through 17, wherein the control information includes the information indicative the type of reference signal resources, wherein the information indicative of the type of reference signal resources identifies that the type of reference signal resources is associated with single-port CSI-RS transmission, or is associated with multi-port CSI-RS transmission.

Aspect 19: The method of any of aspects 16 through 18, wherein the control information includes the information indicative of the type of reference signal resources, wherein the information indicative of the type of reference signal resources identifies that the type of reference signal resources is associated with SSB transmission.

Aspect 20: The method of any of aspects 16 through 19, wherein the capability information includes the information indicative of the first type of beam, wherein the information indicative of the first type of beam identifies whether the first type of beam for which the first network node is capable of generating the beam prediction includes a beam communicated via reference signal resources configured as the measurement resources.

Aspect 21: The method of any of aspects 16 through 20, wherein the capability information includes the information indicative of the first type of beam, wherein the information indicative of the first type of beam identifies a periodicity associated with the first type of beam for which the first network node is capable of generating the beam predictions.

Aspect 22: The method of any of aspects 16 through 21, wherein the capability information includes the information indicative of the first type of beam, wherein the information indicative of the first type of beam identifies a quantity of future time domain occasions for which the first network node is capable of generating the beam predictions, a time interval between adjacent future time domain occasions for the beam prediction, or both.

Aspect 23: The method of any of aspects 16 through 22, further comprising: transmitting signaling indicating a set of combinations of quantities of available reference signal resources and types of available reference signal resources to use as the measurement resources for the beam prediction.

Aspect 24: The method of aspect 23, wherein the capability information includes the information indicative of the first quantity of beams or the first type of beam for which the first network node is capable of generating the beam predictions, wherein the information is based on the set of combinations of available quantities of reference signal resources and available types of reference signal resources indicated by the signaling.

Aspect 25: The method of any of aspects 16 through 24, wherein receiving the capability information comprises: receiving the capability information based on a type of report in which the first network node is capable of transmitting beam prediction results.

Aspect 26: The method of any of aspects 16 through 25, wherein transmitting the control information comprises: transmitting the control information based on a type of report in which the first network node is capable of transmitting beam prediction results.

Aspect 27: The method of any of aspects 16 through 26, further comprising: receiving a report comprising one or more beam prediction results based on the transmitted measurement resources.

Aspect 28: The method of any of aspects 16 through 27, wherein receiving the capability information comprises: receiving the capability information during an initial access procedure.

Aspect 29: The method of any of aspects 16 through 28, further comprising: transmitting a serving cell configuration for the first network node; and receiving, based on the serving cell configuration, the capability information.

Aspect 30: The method of any of aspects 16 through 29, wherein the quantity of reference signal resources is associated with the quantity of available reference signal resources and the type of reference signal resources is associated with the type of available reference signal resources.

Aspect 31: A first network node for wireless communication, comprising a memory; and at least one processor coupled to the memory, wherein the at least one processor is configured to perform a method of any of aspects 1 through 15.

Aspect 32: An apparatus for wireless communication at a first network node, comprising at least one means for performing a method of any of aspects 1 through 15.

Aspect 33: A non-transitory computer-readable medium having code for wireless communication stored thereon that, when executed by a first network node, causes the first network node to perform a method of any of aspects 1 through 15.

Aspect 34: A second network node for wireless communication, comprising a memory; and at least one processor coupled to the memory, wherein the at least one processor is configured to cause the apparatus to perform a method of any of aspects 16 through 30.

Aspect 35: An apparatus for wireless communication at a second network node, comprising at least one means for performing a method of any of aspects 16 through 30.

Aspect 36: A non-transitory computer-readable medium having code for wireless communication stored thereon that, when executed by a second network node, causes the first network node to perform a method of any of aspects 16 through 30.

The methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first network node for wireless communication, comprising:
a memory; and
at least one processor coupled to the memory, wherein the at least one processor is configured to:
transmit capability information including information indicative of at least one of:
a first quantity of beams for which the first network node is capable of generating beam predictions or a first type of beam for which the first network node is capable of generating the beam predictions, wherein the information is based on a quantity of available reference signal resources or a type of available reference signal resources for beam prediction;
receive, based on the capability information, control information including information indicative of a quantity of reference signal resources or a type of reference signal resources to use as measurement resources for beam prediction, and information indicative of a quantity of beams or a beam type to monitor as beam prediction targets; and
monitor the measurement resources in accordance with the quantity of beams or the beam type indicated by the control information.

2. The first network node of claim 1, wherein:
the control information includes the information indicative of the type of reference signal resources,
the information indicative of the type of reference signal resources identifies a reference signal resource periodicity.

3. The first network node of claim 1, wherein:
the control information includes the information indicative of the type of reference signal resources,
the information indicative of the type of reference signal resources identifies that the type of reference signal resources is associated with single-port channel state information reference signal transmission, or is associated with multi-port channel state information reference signal transmission.

4. The first network node of claim 1, wherein:
the control information includes the information indicative of the type of reference signal resources,
the information indicative of the type of reference signal resources identifies that the type of reference signal resources is associated with synchronization signal block transmission.

5. The first network node of claim 1, wherein:
the capability information includes the information indicative of the first type of beam,
the information indicative of the first type of beam identifies whether the first type of beam for which the first network node is capable of generating the beam predictions includes a beam communicated via reference signal resources configured as the measurement resources.

6. The first network node of claim 1, wherein:
the capability information includes the information indicative of the first type of beam,
the information indicative of the first type of beam identifies a periodicity associated with the first type of beam for which the first network node is capable of generating the beam predictions.

7. The first network node of claim 1, wherein:
the capability information includes the information indicative of the first type of beam,
the information indicative of the first type of beam identifies a quantity of future time domain occasions for which the first network node is capable of generating the beam predictions, a time interval between adjacent future time domain occasions for the beam prediction, or both.

8. The first network node of claim 1, wherein the at least one processor is further configured to:
receive signaling indicating a set of combinations of quantities of available reference signal resources and types of available reference signal resources to use as the measurement resources for the beam prediction.

9. The first network node of claim 8, wherein:
the capability information includes the information indicative the first quantity of beams or the first type of beam for which the first network node is capable of generating the beam predictions,
the information is based on the set of combinations of quantities of available reference signal resources and types of available reference signal resources indicated by the signaling.

10. The first network node of claim 1, wherein, to transmit the capability information, the at least one processor is configured to:
transmit the capability information based on a type of report in which the first network node is capable of transmitting beam prediction results.

11. The first network node of claim 1, wherein, to receive the control information, the at least one processor is configured to:
receive the control information based on a type of report in which the first network node is capable of transmitting beam prediction results.

12. The first network node of claim 1, wherein the at least one processor is further configured to:
transmit a report comprising one or more beam prediction results based on the monitored measurement resources.

13. The first network node of claim 1, wherein, to transmit the capability information, the at least one processor is configured to:
transmit the capability information during an initial access procedure.

14. The first network node of claim 1, wherein the at least one processor is further configured to:
receive a serving cell configuration for the first network node; and
transmit, based on the serving cell configuration, the capability information.

15. The first network node of claim 1, wherein the quantity of reference signal resources is associated with the quantity of available reference signal resources and the type of reference signal resources is associated with the type of available reference signal resources.

16. The first network node of claim 1, wherein the at least one processor is further configured to:
receive a report comprising one or more beam prediction results based on the transmitted measurement resources.

17. A second network node for wireless communication, comprising:
a memory; and
at least one processor coupled to the memory, wherein the at least one processor is configured to:
receive capability information including information indicative of at least one of:
a first quantity of beams for which a first network node is capable of generating beam predictions or a first type of beam for which the first network node is capable of generating the beam predictions, wherein the information is based on a quantity of available reference signal resources or a type of available reference signal resources for beam prediction;
transmit, based on the capability information, control information including information indicative of a quantity of reference signal resources or a type of reference signal resources as measurement resources for beam prediction, and information indicative of a quantity of beams or a beam type to monitor as beam prediction targets, and
transmit the measurement resources in accordance with the quantity of beams or the beam type indicated by the control information.

18. The second network node of claim 17, wherein:
the control information includes the information indicative of the type of reference signal resources,
the information indicative of the type of reference signal resources identifies a reference signal resource periodicity.

19. The second network node of claim 17, wherein:
the control information includes the information indicative the type of reference signal resources,
the information indicative of the type of reference signal resources identifies that the type of reference signal resources is associated with single-port channel state information reference signal transmission, or is associated with multi-port channel state information reference signal transmission.

20. The second network node of claim 17, wherein:
the control information includes the information indicative of the type of reference signal resources,
the information indicative of the type of reference signal resources identifies that the type of reference signal resources is associated with synchronization signal block transmission.

21-30. (canceled)
